(19) United States
(12) Patent Application Publication
(10) Pub. No.: US 2025/0298871 A1
(43) Pub. Date: Sep. 25, 2025

(54) EmMARK: ROBUST WATERMARKS FOR IP PROTECTION OF EMBEDDED QUANTIZED LARGE LANGUAGE MODELS

(71) Applicant: The Regents of the University of California, Oakland, CA (US)

(72) Inventors: Ruisi Zhang, San Diego, CA (US); Farinaz Koushanfar, San Diego, CA (US)

(21) Appl. No.: 19/088,171

(22) Filed: Mar. 24, 2025

Related U.S. Application Data
(60) Provisional application No. 63/568,631, filed on Mar. 22, 2024.

(51) Int. Cl. G06F 21/16; G06N 3/10

(52) U.S. Cl. CPC G06F 21/16; G06N 3/10

(57) ABSTRACT

In some embodiments, there is provided a computer-implemented method for watermarking selected weights of a machine learning model. In some embodiments, a method includes receiving a quantized machine learning model comprising a plurality of layers associated with a plurality of weights; determining, for each of the plurality of weights, a corresponding score indicative of an effect of the corresponding weight on an output of the quantized machine learning model; selecting, based on the scores, a set of the plurality of weights having a corresponding score below a threshold; selecting, from the set of the plurality of weights, a subset of the plurality of weights for insertion of a signature; and inserting a signature on each of the weights of the subset of the plurality of weights. Related systems, methods, and articles of manufacture are also disclosed.

### CROSS-REFERENCE TO RELATED APPLICATIONS

This application claims the benefit of priority under 35 U.S.C. § 119(e) to U.S. Provisional Patent Application No. 63/568,631, filed Mar. 22, 2024, and titled “EmMARK: ROBUST WATERMARKS FOR IP PROTECTION OF EMBEDDED QUANTIZED LARGE LANGUAGE MODELS,” the contents of which are hereby incorporated by reference in their entirety.

### SUMMARY

In some example embodiments, there may be provided watermarks for embedded quantized large language models (LLMs).

In some embodiments, there is provided a system that includes receiving a quantized machine learning model comprising a plurality of layers associated with a plurality of weights, wherein the quantized machine learning model is quantized by at least transforming at least some of the plurality of weights from a first quantity of bits to a second, lower quantity of bits; determining, for each of the plurality of weights, a corresponding score indicative of an effect of the corresponding weight on an output of the quantized machine learning model; selecting, based on the scores, a set of the plurality of weights having a corresponding score below a threshold; selecting, from the set of the plurality of weights, a subset of the plurality of weights for insertion of a signature; and inserting a signature on each of the weights of the subset of the plurality of weights.

In some variations, the quantized machine learning model is quantized by at least transforming at least some of the plurality of weights from a first quantity of floating point bits to a second, lower quantity of integer bits. The first quantity of floating point bits is 32-bit floating point and the second, lower quantity of integer bits is 8-bits. The corresponding scores are determined using a scoring function. The scoring function determines sensitivity at the output due at least in part to signature removal and/or determines contribution of the corresponding weight to the output The selecting, from the set of the plurality of weights, the subset of the plurality of weights for insertion of the signature comprises randomly selection the subset of the plurality of weights. There may also be included extracting, from the quantized machine learning model, a signature; and comparing the extracted signature to the inserted signature previously inserted by the inserting. Moreover, the quantized machine learning model is a compressed large language model and/or a compressed neural network.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a system in accordance with some embodiments described herein;

FIG. 2 illustrates a method in accordance with some embodiments described herein; and

FIG. 3 illustrates a computing system in accordance with some embodiments describes herein.

### DETAILED DESCRIPTION

Machine learning model watermarking refers to adding digital signatures (e.g., watermarks) onto the model parameters (e.g., weights) to enable ownership proof. Watermarking protects the large language model (LLM) proprietor's intellectual property by inserting unique signatures onto the LLM parameters. Past approaches may insert signatures (also referred to as “digital signatures,” watermarks, and “digital watermarks”) into LLM model parameters but the inserting may fall into two approaches: (i) training-time watermarking and (ii) post-training watermarking. These past approaches may be somewhat robust to potential attacks, but they may require significant computational and memory resources, so these past approaches may be hard to scale when an LLM can include hundreds of thousands, millions, billions or even trillions of parameters.

Disclosed herein are novel systems, methods, and articles of manufacture for inserting signatures onto LLM model parameters in a computationally efficient manner, when compared to past approaches. In this way, the digital signature may be used to protect a large language models deployed on, for example, a resource-constrained edge devices as well as other types of devices. Although some of the examples refer to applying the signature to LLM, the disclosed signatures may be applied to other types of machine learning (ML) models, such as neural networks, convolutional neural networks, and/or the like.

To address the IP theft risks posed by malicious end-users, the systems, methods, and articles of manufacture described herein enable users (e.g., proprietors, owners, hosts, and/or the like of an LLM) to authenticate ownership of a machine learning model by querying the LLM's weights (which have been watermarked with the signatures) and matching the signatures that are inserted on the LLM's weights. As described herein, strategic watermark weight parameters selection helps to ensure robustness and maintain ML model, such as LLM, quality upon the insertion of a signature. The disclosed signature (e.g., watermark) insertion result in signatures that may be resilient against removal and forging attacks, and may be efficient both in terms of time and computation overheads.

Further, deploying LLM's can be resource intensive. As noted, LLM may include hundreds of hundreds of thousands, millions, billions or even trillions of parameters or weights. Some of the examples herein refer to “weights” and “parameters” interchangeably, but the parameters refer to more broadly to the ML model or LLM weights, biases, and/or other numerical values (which are adjusted during training) and define the behavior ort the ML model or LLM. The term “weights” formally refers to numerical values that define the strength of connections between neurons (also referred to as nodes) across different layers in the ML model or LLM model, while the term “biases” refer to numerical values added to a weighted sum of inputs before being passed through an activation function (e.g., a node or neural). Moreover, the parameters may

The resource intensity of LLMs for example may be more pronounced in resource constrained devices, such as edge devices (e.g., smartphone, network edge servers, and/or the like). As such, these devices may use compressed version of an LLM or ML model to reduce the model's memory size, bandwidth, and/or resource usage. To that end, an edge device may execute a compressed ML model or LLM model using quantized parameters and/or weights. Rather than use floating point types for the model parameters and weights, the model may use integer types for the parameters and weights. This quantized ML or ML model may thus realize a smaller memory footprint, result in quicker training, and/or faster execution, when compared to the same model using uncompressed, floating point parameters and weights. And the benefits of smaller memory footprint and the like may be more pronounced as the model parameters increase in size (e.g., from hundreds of thousands, millions, to billions or even trillions).

The quantized LLM (which as noted may be embedded may thus reduce memory cost (as well as processor energy usage) for inference tasks while enhancing local data privacy protection. Optimizing for the most quantized LLM within a quality bound is computationally costly, and thus, the resulting models become valuable intellectual property (IP) for the owners. As noted, the term “quantized” may be used to describe a machine learning model that uses lower-precision data types (e.g., 8-bit integers) for the parameters to reduce computational and memory costs, rather than full-precision (e.g., 32-bit floating-point numbers

Due to the considerable fine-tuning overhead, training-aware quantization may be challenging to apply to LLMs. To address this, post-training quantization may be used to quantize LLMs without introducing significant computation burdens. Given the floating-point tensor X, the number of bits N to quantize, Equation 1 below depicts how X is quantized into X with quantization step size Δ. In LLM quantization, the tensor X can the parameters, weights, and/or activations, depending on the constraints in the target platform.

$$\overline{X} = Round ( \frac{X}{Δ} ) , Δ = \frac{max ( \vert X \vert )}{{2}^{N - 1} - 1} . \qquad ( 1 )$$

The phrase “activations” refer to the outputs of LLM or ML mode's neurons during inference (which may represent intermediate values). For the sake of ease of explanation, the examples disclosed herein may refer to parameters in a more generic sense so as to include weights and activation (unless said otherwise).

Post-training quantization of the ML model may be performed in at least two ways: (1) INT8 quantization, where activation and/or weights are quantized from 32-bit floating point into 8-bit integer; or (2) a Low-bit quantization, where activation and/or weights are quantized to low-precision bits, such as 8-bit integers, 4-bit integers, and even 1-bit integers. For INT8 quantization, the LLM's activations may be difficult to process due to extremely high outlier magnitudes in some weight channels. Llm.int8( ) may be used for mixed-precision decomposition to isolate the outlier activations into a float16 (16-bit floating point) matrix multiplication. The rest of the parameters of the LLM model may then use INT8 computation. In other words, some of the LLM model parameters may be reduced from 32-bit floating point to a 16-bit floating point, while other may be reduced to 8-bit integers (or 4, or 1, for example). Outlier suppression improves the scheme by applying non-scaling Layer Normalized (e.g., LayerNorm) and token-wise clipping may be used as well to reduce outliers. SmoothQuant may be used to enhance the INT8 quantization using a mathematically equivalent transformation(s) to migrate high-magnitude activations and to migrate low-magnitude weights. SmoothQuant smooths the activation outliers by offline migrating the quantization difficulty from activations to weights with a mathematically equivalent transformation. For Low-bit quantization, GPTQ may be used for second-order methods to obtain a closed-form solution for the low-bit quantization optimization. However, GPTO overfits the calibration dataset, and has bad generalization to new dataset distributions at the inference time. Activation-aware weight optimization (AWQ) may be used to improve low-bit quantization by identifying the salient weights in LLMs and rescaling the salient weights before quantization.

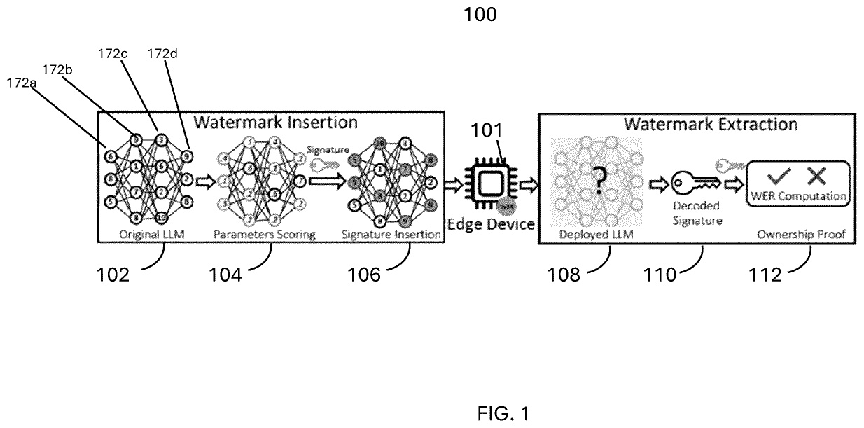

FIG. 1 illustrates an example of a process flow 100 in accordance with some embodiments described herein. The process flow 100 comprises an edge device 101. In some implementations, the edge device 101 comprises, for example, a smartphone, a laptop, or a virtual home assistant, Internet of Things device, a wearable device, and/or a network edge device, (e.g., edge server, edge wireless access point, etc.), although other types of processors and memory (configured with instructions) based devices may be used as well. In the example of FIG. 1, the edge device 101 may be resource-constrained, when compared to an LLM hosted by an enterprise (e.g., ChatGPT hosted in the cloud by its provider). For example, the edge device may have reduced amounts of memory, bandwidth, processing capability, power, and/or the like, when compared to an enterprise scale host.

The edge device 101 may be configured to run a machine learning model 102, such as a a large language model (LLM). As noted, the machine learning model 102 may be compressed by quantizing the parameters (e.g., parameters, weights, and activations) of the ML model. For example, the machine learning model 102 may have some if not all of the parameters compressed to use N-bits (e.g., compress the 32-bit floating point parameters to 16, 8, 4, 2, or even 1 bit). In some embodiments, some if not all of the parameters are compressed by quantizing from 32-bit floating point parameters to 8-bit integer type parameters.

The example of FIG. 1 also depicts an input layer 172a, two inner layers 172b-c, and an output layer 172d, although the ML model may have more of fewer layers as well. Each layer of the plurality of layers (e.g., the input layer 172a, two inner layers 172b-c, and the output layer 172d) includes nodes (also referred to as neurons and depicted by circles); the nodes are connected by weights that are depicted by the lines or connections between the nodes. As noted above, the ML model 102 in a post training state and thus ready for inferences and use by the end user.

The process flow 100 may include scoring one or more if not all of the weights of the ML model 102. The score 104 determined for a corresponding weight may be indicative of an effect of the weight on an output of the machine learning model 102, and/or the score 104 determined for a weight may further be indicative of a sensitivity of the weight to the insertion of a signature (e.g., a watermark).

Based on the score 104, a signature may be inserted (e.g., added) at 106 to at least a first weight of the plurality of weights associated with the layers of the machine learning model 102. For example, the signature may be added 106 to at least a first weight of the plurality of weights, wherein at least the first weight may be selected based on the score indicating the smallest effect (when compared to the other weights) on the output of the machine learning model 102, so as to prevent the insertion 106 of the signature from interfering with the quality of the output of the machine learning model 102. Alternatively, or additionally, The signature may be inserted (based on the signature) to at least the first weight that is also least sensitive to the insertion 106 of the signature.

In some implementations, the signature may be based on a discrete cosine transform of a weight, although the signature may be implemented in other ways as well. For example, the weights are transformed using a discrete cosine transform (DCT) into the DCT domain and the signature is applied to the DCT domain weight(s). Although this example describes applying the signature in the DCT domain, the signature may be applied in other transform domains as well.

In some implementations, the process flow 100 takes a N-bit compressed and quantized machine learning model 102 M and a signature sequence B={b₁, b₂, . . . , b_{|B|}} as input. The machine learning model 102 M may comprise a plurality of weights W. In the signature sequence B, each element bᵢ∈{−1, 1}. The signature (e.g., watermarks) 106 are inserted into M's weights W. Each weight W of the plurality of weights may comprise a two-dimensional matrix. Each column of W comprises a weight channel.

In some implementations, the process flow 100 determines an activation A_{f} for each weight of the plurality of weights. In some implementations, the process flow then determines the activations A_{f} given a plurality of example inputs Xₙ into the machine learning model 102. Each of the activations A_{f} may comprise a matrix product of the inputs Xₙ and the weight W. The process flow may include determining an activation distribution based on the computed activations A_{f} for the plurality of example inputs. This may be determined by computing statistics (e.g., an average, a minimum, a maximum, etc.) for the computed activations. The activation of each weight channel (e.g., each column of a matrix W) refers to a corresponding entry in the matrix product of the inputs Xₙ and the weight W.

To determine a weight of the quantized machine learning model 102 that preserves the output of the machine learning model 102 and is robust against removal and forging attacks, Equation 2 may be used:

$$S = α {S}_{q} + β {S}_{r} \qquad ( 2 )$$

In Equation 1, S_{q} evaluates the quality preservation of a weight of the plurality of weights and Sᵣ assesses the robustness of the weight to signature removal and forging attacks. The two scores are combined by for example using the coefficients α and β (α, β>0).

For i-th quantized weight parameter Wᵢ, the corresponding quality score S_{q} and saliency Sᵣ may be determined to accommodate signature bⱼ as follows. The first quality score S_{q} is defined in Equation 3.

$${s}_{q} = \vert \frac{{b}_{j}}{{W}_{i}} \vert \qquad ( 3 )$$

A smaller S_{q} indicates the weight is less sensitive to signature insertions. Weight parameters with larger absolute values are less sensitive to slight changes (additions/deletions) from signature insertion (in other words, larger Wᵢ results in smaller S_{q}). Thus, insertion of signatures onto weights having larger absolute values results in better quality preservation of the output of the machine learning model 102. In some implementations, Wᵢ in the minimum and maximum quantization level is set to 0 before scoring.

The saliency score Sᵣ is defined in Equation 4.

$${S}_{r} = \vert \frac{max ( {𝒜}_{f} )}{{𝒜}_{fi} - min ( {𝒜}_{f} )} \vert \qquad ( 4 )$$

As used herein, “salient” refers to model parameters (e.g., weights) that contribute most to the performance of the machine learning model 102. Parameter saliency has strong correlations with the activation magnitudes. In other words, weights having larger corresponding activations process more incoming features, and their corresponding weight channels are thus more salient. The saliency of the weight parameter in each channel is thus defined according to Equation 4 as the normalization of current channel magnitude A_{fi}. A smaller saliency Sᵣ indicates the weight channel contributes more to the LLM quality.

The saliency Sᵣ characterizes the robustness of each quantized weight parameter. Determination of the robustness of each quantized weight parameter defends against signature removal attacks and forging attacks. Signature removal attacks are prevented by using the robustness to ensure that signature insertion is performed on a salient region of the machine learning model 102. In particular, to remove an inserted signature, an adversary would have to perturb a larger fraction of weights in a salient region of the machine learning model 102. Such perturbation of a larger fraction of weights would result in performance degradations of the machine learning model 102.

The process flow 100 scores each quantized weight parameter (e.g., weight) using Equations 1-4, and obtain the scores for each weight W. For the i-th weight parameter Wᵢ, a smaller score means that the parameter is a better candidate for signature insertion.

For a n quantization layer model, the process flow 100 may choose a set of weights from the plurality of weights based on their scores (e.g., pick the weights having the smaller score such as a score below a threshold value (which may be predetermined threshold value, user-defined, or determined in other ways). For example, the weights in the subset may be chosen as follows: choose B_{c} smallest candidate weight parameters from W plurality of weights in a layer (of the quantized ML model) as candidate locations for signature insertion. The number B_{c} of selected weights/parameters may be chosen from the ML model as a whole (rather than by a per layer basis). Alternatively, or additionally, the number B_{c} of selected weights/parameters may, as noted be a predetermined value, user-defined, or determined in other ways. A subset of weights may be selected from among the B_{c} candidate weights parameters for insertion of a signature. The subset of weights may be selected (e.g., randomly including semi-randomly) from among the B_{c} candidate weights parameters. In some implementations, |B|<<|B_{c}|×n, where |B| represents the length of the signature B to be encoded into the machine learning model 102, |B_{c}| represents the length of the signature candidate

For signature insertion 106 for a n quantization layer of the machine learning model 102,

$$\frac{\vert B \vert}{n} n$$

signatures may be inserted into each layer of the machine learning model 102. In some implementations, to maintain the secrecy of inserted signatures, the process flow 100 may, as noted, randomly (including semi-randomly) choose

$$\frac{\vert B \vert}{n}$$

weight parameters out of the |B_{c}| candidates in the current layer using random seed d. The process flow 100 may obtain the signature weight locations L and may encode the signatures into the quantized weights W according to Equation 5 as follows:

$${𝒲}^{′} [ {L}_{i} ] = 𝒲 [ {L}_{i} ] + {b}_{i} for i ∈ [ 1 , \vert B \vert ] \qquad ( 5 )$$

In some implementations, a signature added at signature addition 106 comprises at least one of a signature sequence B, a random seed d, an original quantized weight W, a full-precision activation A_{f}, or coefficients α, β for location (L) reproduction.

The process flow 100 may further extract signatures that are inserted at 106. In particular, the process flow may extract a signature from the watermarked machine learning model 106 to prove ownership of the machine learning model 102 or to detect that the ML model 106 has been tampered with (e.g., modified, copied, maliciously hacked, and/or the like without the consent of the ML model 106 owner). To that end, the process flow 100 may reproduce the signature/watermark weight locations L with the random seed d, quantized model weights W, full-precision activation A_{f}, and α, β coefficients.

At a given location L, the process flow 100 may compare the extracted weight W [L] at 110 with the original weight W[L] at 106 to determine a difference (if any) between the extracted weight W[L] and the original weight W[L]. For example, the process flow may determine ΔW[L] which is a difference between the extracted weight W[L] and the original weight W[L] according to for example Equation 6:

$$Δ𝒲 [ L ] = {𝒲}^{′} [ L ] - 𝒲 [ L ] . \qquad ( 6 )$$

In this way, ML model owners can assert ownership by comparing ΔW[L] with inserted signature sequence B. The process flow 100 may also determine signature extraction rates % ER according to for example Equation 7:

$$\% ER = 100 \times \frac{{\vert B \vert}^{′}}{\vert B \vert} . \qquad ( 7 )$$

In Equation 7, |B| is the length of the inserted signature, and |B|′ is the number of matching signature bits. The process flow 100 may evaluate the probability P_{c} that a non-watermarked ML model matches the inserted signatures by chance. In Equation 8 below, k is the number of matching bits between the owner's and non-watermarked model's signatures. |B| is the signature length; the signature generation follows the Rademacher distribution, and each bit has an equal probability of 0.5 to be 1 or −1:

$${P}_{c} = {\sum }_{i = k}^{\vert B \vert} ( \begin{matrix}\vert B \vert \\ i\end{matrix} ) 0. {5}^{\vert B \vert} . \qquad ( 8 )$$

Forging attacks may be prevented or detected by determining the parameter scores using a full-precision ML model. In a forging attack, an adversary does not remove the LLM owners' watermark (e.g., digital signature). Instead, the adversary claims the ML model ownership by faking another set of watermarks/digital signatures. This may be achieved by (i) counterfeiting the digital signatures/watermark weight locations Lₐ with a fake signature sequence and/or (ii) re-watermarking (re-digital signature) on top of the watermarked embedded ML model/LLM by a counterfeited full-precision model activations and insertion hyperparameters. However, an adversary would have to have access to the full-precision ML model to be able to reproduce the score Sᵣ for signature counterfeiting. As such, the process flow may include inserting signatures that are resilient to forging attacks with a confidential full-precision ML model's activation which the adversary does not have access to.

The digital signatures inserted by the process flow 100 may be further resilient to parameter overwriting attacks (in which an adversary removes a watermark/signature) by randomly adding for example one bit to the parameter weights in the watermarked/signed model. The attacked ML model performance may drop as more bits are overwritten. The signatures inserted by the process flow 100 are also resilient to re-watermark attacks, in which an adversary may know a general signature insertion algorithm. However, the adversary cannot access the ML model owners' signatures or random seeds. The adversary tries to break the watermark by perturbing parameters potentially used for watermarking, resulting in further degradation of model quality.

The signature inserted by the process flow 100 may be configured for extraction. Extraction of the signature inserted by the process flow 100 can be used to establish or verify ownership of the LLM. In some implementations, the process flow 100 may be configured to extract the signature by reproducing the scoring function that is used to obtain the watermark weight locations using the random seed, original model weights, and full precision model activations. Then, an ML model proprietor may query the watermarked model and decode the signatures at the watermark weight locations. The ownership can be claimed by comparing the encoded and decoded signatures.

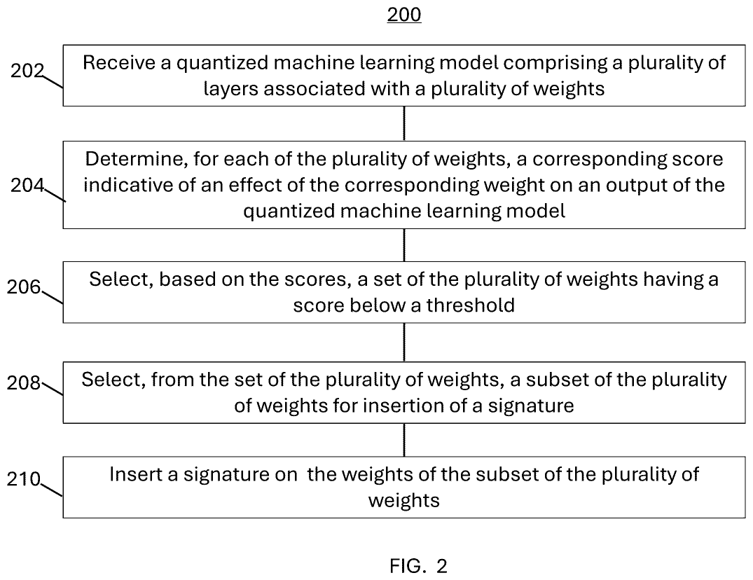

FIG. 2 illustrates an example of a process, such as a computer-implemented method 200, in accordance with some embodiments described herein.

At 202 of the method 200, a quantized machine learning model is received.

Referring to the example of FIG. 1, the machine learning model 102 may be quantized such that at least some of the weights are compressed by transforming at least some of the plurality of weights from a first quantity of bits to a second, lower quantity of bits. As noted, the quantization of the ML model may include transforming some of (if not all) the weights from 32-bit floating point type weights to 8-bit integer type weights (e.g., from a first quantity of floating point bits to a second, lower quantity of integer bits). Moreover, the quantized ML model 102 may be compressed in this way to enable operation on a resource constrained edge device, although the ML model 102 may operate on devices that are not so resource constrained as well. Moreover, the ML model may comprise a neural network, LLM, and/or other type of ML model including weights and layers 176a-d, for example.

At 204, the process may include determining, for each of the plurality of weights, a corresponding score indicative of an effect of the corresponding weight on an output of the quantized machine learning model. For example, for some (if not all) of the weights of the ML model, are scored (i.e., determining a score). The corresponding scores for the weights may be determined using a scoring function (see also for example, Equations 1-4). The scoring function provides or determines sensitivity at the output of the ML model caused by or due at least in part to signature removal from the corresponding weight and/or determines a contribution of the corresponding weight to the output of the model output. In the example above, weights with smaller scores are better candidates for signature/watermark insertion when compared to higher scoring weights.

In some implementations, the score is computed based on an absolute value of the corresponding weight of the plurality of weights. The score indicative of the effect of the corresponding weight on the output of the quantized machine learning model may be determined at least in part by Equation 3 above. According to Equation 3, the larger the absolute value of the corresponding weight, the less sensitive the corresponding weight is to insertion of a signature. Thus, the insertion of a signature on a weight having a larger absolute value has less of an effect on the output of the quantized machine learning.

In some implementations, the score is computed based on a saliency of the corresponding weight. In some implementations, the score indicative of the effect of the first weight on the output of the quantized machine learning model may be determined at least in part by Equation 4 above. According to Equation 4, the larger the activation of a given weight channel, the larger the saliency of the weight channel to the LLM quality.

At 206, the process may further include selecting, based on the scores, a set of the plurality of weights having a corresponding score below a threshold. Referring to FIG. 1, the ML model 102 has been scored as noted at 204. In this example, the set of weights are selected based on their scores. The threshold may be predefined, a default value, selected based on device constraints, and/or selected by a user. The threshold may be selected such that the weights that have corresponding scores that fall below the threshold corresponding to the best weights candidates for signature insertion.

At 208, the process may include selecting, from the set of the plurality of weights, a subset of the plurality of weights for insertion of a signature. For example, from the set of the plurality of weights selected at 206, a further down selection may be performed to a subset of theses weights. It is from this subset of weights that are considered candidates for insertion of the signature. In some implementations, the subset may be randomly (including semi-randomly) selected. The random (or semi-random) selection may enable enhanced detection of tampering, fraud, etc. of the ML model.

At 210, a signature is inserted on the weights of the subset of the plurality of weights. Referring to FIG. 1, supposing all of the weights at the layer 172 of ML model 102 are selected at 206 as being below a threshold, at 206, the process may include randomly selecting some of the weights at layer 172, and then at 210, these randomly selected weights have a digital signature (e.g., watermark) applied. At this stage, the machine learning model 106 has one or more watermarked weights (e.g., having weights with signatures inserted thereon), so the machine learning model 106 can be used to perform inferences at the ML model output. The output of the machine learning model having watermarked weights can be analyzed as noted such for ownership verification, tampering, fraud, and/or the like.

As noted above, the signature inserted into one or more of the weights may be extracted, from the quantized machine learning model and then the extracted signature may be compared to the inserted signature previously or originally inserted at 210. As noted, the quantized machine learning model having inserted signatures may be a compressed large language model and/or a compressed neural network.

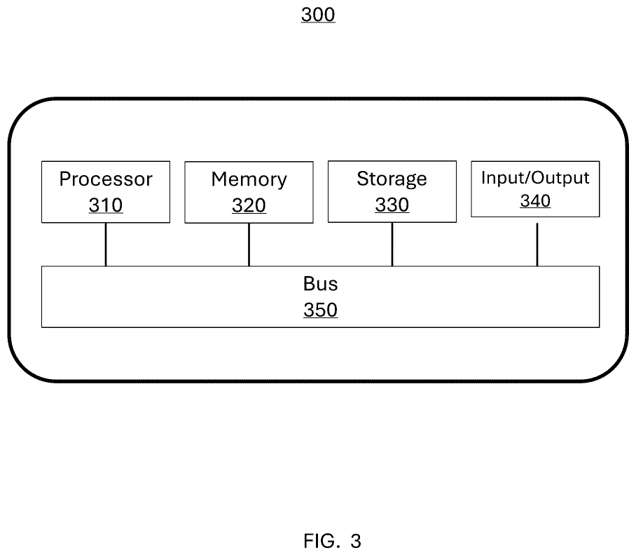

FIG. 3 depicts a block diagram illustrating a computing system 300 consistent with implementations of the current subject matter. For example, the system 300 can be used to host the process flow 100. The system 300 may be further configured to implement the method 200 of FIG. 2. As shown in FIG. 3, the computing system 300 can include a processor 310, a memory 320, a storage device 330, and input/output devices 340. The processor 310, the memory 320, the storage device 330, and the input/output devices 340 can be interconnected via a system bus 350. The processor 310 may be capable of processing instructions for execution within the computing system 300. In some implementations of the current subject matter, the processor 310 can be at least one single-threaded processor, at least one multi-threaded processor, at least one graphic processor unit (GPU), at least one AI (or machine learning) chip/processor, and/or the like. The processor is configured to process instructions stored in the memory and/or on the storage device to display graphical information for a user interface provided via the input/output device. The memory is a computer readable medium (also referred to as non-transitory computer-readable medium) such as volatile or non-volatile that stores information within the computing system. The storage device is capable of providing persistent storage for the computing system. The storage device can be a floppy disk device, a hard disk device, an optical disk device, or a tape device, or other suitable persistent storage means. The input/output device provides input/output operations for the computing system. In some implementations of the current subject matter, the input/output device includes a keyboard and/or pointing device. In various implementations, the input/output device includes a display unit for displaying graphical user interfaces. According to some implementations of the current subject matter, the input/output device can provide input/output operations for a network device. For example, the input/output device can include Ethernet ports or other networking ports to communicate with one or more wired and/or wireless networks (e.g., a local area network (LAN), a wide area network (WAN), the Internet).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed:

1. A system comprising:
at least one processor; and
at least one memory including instructions which when executed by the at least one processor causes operations comprising:
receiving a quantized machine learning model comprising a plurality of layers associated with a plurality of weights, wherein the quantized machine learning model is quantized by at least transforming at least some of the plurality of weights from a first quantity of bits to a second, lower quantity of bits;
determining, for each of the plurality of weights, a corresponding score indicative of an effect of the corresponding weight on an output of the quantized machine learning model;
selecting, based on the scores, a set of the plurality of weights having a corresponding score below a threshold;
selecting, from the set of the plurality of weights, a subset of the plurality of weights for insertion of a signature; and
inserting a signature on each of the weights of the subset of the plurality of weights.

2. The system of claim 1, wherein the quantized machine learning model is quantized by at least transforming at least some of the plurality of weights from a first quantity of floating point bits to a second, lower quantity of integer bits.

3. The system of claim 2, wherein the first quantity of floating point bits is 32-bit floating point and the second, lower quantity of integer bits is 8-bits.

4. The system of claim 1, wherein the corresponding scores are determined using a scoring function.

5. The system of claim 4, wherein the scoring function determines sensitivity at the output due at least in part to signature removal and/or determines contribution of the corresponding weight to the output.

6. The system of claim 1, wherein the selecting, from the set of the plurality of weights, the subset of the plurality of weights for insertion of the signature comprises randomly selection the subset of the plurality of weights.

7. The system of claim 1, further comprising:
extracting, from the quantized machine learning model, a signature; and
comparing the extracted signature to the inserted signature previously inserted by the inserting.

8. The system of claim 1, wherein the quantized machine learning model is a compressed large language model and/or a compressed neural network.

9. A computer-implemented method comprising:
receiving a quantized machine learning model comprising a plurality of layers associated with a plurality of weights, wherein the quantized machine learning model is quantized by at least transforming at least some of the plurality of weights from a first quantity of bits to a second, lower quantity of bits;
determining, for each of the plurality of weights, a corresponding score indicative of an effect of the corresponding weight on an output of the quantized machine learning model;
selecting, based on the scores, a set of the plurality of weights having a corresponding score below a threshold;
selecting, from the set of the plurality of weights, a subset of the plurality of weights for insertion of a signature; and
inserting a signature on each of the weights of the subset of the plurality of weights.

10. The method of claim 9, wherein the quantized machine learning model is quantized by at least transforming at least some of the plurality of weights from a first quantity of floating point bits to a second, lower quantity of integer bits.

11. The method of claim 10, wherein the first quantity of floating point bits is 32-bit floating point and the second, lower quantity of integer bits is 8-bits.

12. The method of claim 9, wherein the corresponding scores are determined using a scoring function.

13. The method of claim 12, wherein the scoring function determines sensitivity at the output due at least in part to signature removal and/or determines contribution of the corresponding weight to the output.

14. The method of claim 9, further comprising:
extracting, from the quantized machine learning model, a signature; and
comparing the extracted signature to the inserted signature previously inserted by the inserting.

15. The method of claim 9, wherein the quantized machine learning model is a compressed large language model and/or a compressed neural network.

16. A non-transitory machine-readable medium storing instructions that, when executed by at least one processor, cause the at least one processor to perform operations comprising:
receiving a quantized machine learning model comprising a plurality of layers associated with a plurality of weights, wherein the quantized machine learning model is quantized by at least transforming at least some of the plurality of weights from a first quantity of bits to a second, lower quantity of bits;
determining, for each of the plurality of weights, a corresponding score indicative of an effect of the corresponding weight on an output of the quantized machine learning model;
selecting, based on the scores, a set of the plurality of weights having a corresponding score below a threshold;
selecting, from the set of the plurality of weights, a subset of the plurality of weights for insertion of a signature; and
inserting a signature on each of the weights of the subset of the plurality of weights.

17. The non-transitory machine-readable medium of claim 16, wherein the quantized machine learning model is quantized by at least transforming at least some of the plurality of weights from a first quantity of floating point bits to a second, lower quantity of integer bits.

18. The non-transitory machine-readable medium of claim 17, wherein the first quantity of floating point bits is 32-bit floating point and the second, lower quantity of integer bits is 8-bits.

19. The non-transitory machine-readable medium of claim 16, wherein the corresponding scores are determined using a scoring function.

20. The non-transitory machine-readable medium of claim 19, wherein the scoring function determines sensitivity at the output due at least in part to signature removal and/or determines contribution of the corresponding weight to the output.
